(19) United States
(12) Patent Application Publication
(10) Pub. No.: US 2023/0148104 A1
(43) Pub. Date: May 11, 2023

(54) RELIEF VALVE

(71) Applicant: Aroma System s.r.l., Bologna (IT)

(72) Inventors: Gino RAPPARINI, Bologna (IT); Massimiliano CRISTIANI, Bologna (IT)

(21) Appl. No.: 17/911,324

(22) PCT Filed: Mar. 19, 2021
(86) PCT No.: PCT/IB2021/052317

§ 371 Date: Sep. 13, 2022

(30) Foreign Application Priority Data
Mar. 19, 2020 (IT) 102020000005932

(51) Int. Cl. B65D 77/22

(52) U.S. Cl. CPC B65D 77/225; B65D 2205/00

(57) ABSTRACT

A one-way relief valve for hermetically sealed packages is disclosed, wherein said valve comprises a valve body (100) made of a lower support surface (102) provided with vent holes (101) and a flexible membrane (110) associated with said lower support surface (102) that is capable of switching between a configuration in which the valve is closed and a configuration in which the valve is open. Said membrane (110) is characterised in that it is coloured, in order to facilitate visual inspection by the operator or the machine during the assembly of the valve and/or the production of hermetically sealed packages provided with the valve.

### TECHNICAL FIELD

The present invention relates to the field of one-way relief valves for hermetically sealed packages, for example, coffee packages or the like.

### PRIOR ART

Several types of one-way relief valves for hermetically sealed food packages, such as coffee packages, are known from the state of the art.

For example, document IT 1248238 describes a one-way relief valve comprising a valve body provided with a vent hole, a flexible membrane placed on a viscous layer so as to cover this vent hole, and a disc made so as to completely cover the membrane and close the valve.

A one-way relief valve comprising a rigid valve body, an elastic membrane, a containment lid and a filter element and made entirely of biodegradable materials, is described in BO 2007A000251.

A one-way relief valve comprising a valve body and a membrane, without further means of attaching the membrane to the valve, is described for example in EP 2396243 A1.

A one-way relief valve comprising a valve body and a membrane associated with the valve body by means of an oil layer, is described in EP 1538106 A1.

The most recent relief valves known in the state of the art do not generally comprise plugs or sealing means for fixing the membranes to the valve body. Furthermore, relief valves known in the state of the art typically comprise thin, transparent flexible membranes that are not easily visible from the outside. It is, therefore, very difficult to verify the actual presence of the membrane on the valve during the assembly of the valve and/or the production of the hermetically sealed packages provided with the valve. It is, therefore, likely that, under these conditions, valves without a membrane are assembled, resulting in a degradation of the product contained in the packages due to the exposure to the external environment. The present invention thus addresses the problem of producing relief valves provided with a flexible, thin membrane, wherein the membrane is, however, easily recognisable by an operator and/or a machine during the various steps of the assembly and the production of the valve.

### SUMMARY

The present invention is based on the idea of providing valves having a coloured membrane. In this way, the membrane is easily recognisable from the outside because it is distinguishable from the rest of the valve body.

According to the present invention, a one-way relief valve for hermetically sealed packages, preferably for food, is provided. The valve comprises a valve body having a lower supporting surface provided with one or more vent holes, and a membrane associated with said lower supporting surface. The membrane is capable of switching between a configuration in which it completely covers one or more vent holes on the lower supporting surface of the valve, and a configuration in which said holes are partially uncovered, so that the gas released from the product inside the package can escape from the package through said valve. The valve is characterised in that said membrane is coloured in order to facilitate visual inspection by the operator and/or the machines during the steps of assembling the valve and/or producing the hermetically sealed packages equipped with said valve.

The coloured membrane may be, for example, entirely coloured over its entire surface with one or more colours, so as to stand out from the valve body. According to an alternative configuration, the coloured membrane may be partially coloured and may present coloured patterns, regular or irregular, on a non-coloured background, for example a pattern comprising one or more parallel and/or orthogonal lines and/or defining predefined angles, or a polka dot pattern, or any design, so that the membrane is distinguishable from the valve body.

In particular, it is possible, for example, to colour the membrane with a different colour depending on the features of the membrane, for example the type of material or the opening pressure, which are intended to be highlighted for the operator or the machine during the assembly and production steps, thus further facilitating the production process.

Preferably, such a membrane contains pigments or colourants, or, for example, such a membrane may be covered with a layer of lacquer or other coloured material on one or both surfaces. The coloured membrane can be transparent, translucent or opaque. In fact, the membrane of relief valves is preferably thin, e.g. with a thickness in the range of 0.012 mm to 0.2 mm, and can therefore be transparent or translucent due to its thinness and can be coloured because of the presence of pigments or colourants.

Moreover, the membrane may include particular pigments or a particular print design configured to react with the compounds released by the oxidized product (called secondary products), for example hydrocarbons, esters, aldehydes, ketones, alcohols and acids, so as to change colour when the product itself is oxidized, for instance when the coffee, which is contained in the package provided with the valve according to this embodiment of the invention, is oxidized. This solution is particularly advantageous because the colouring of the membrane makes it possible to detect any oxidation of the product, in the case of transparent packages. Preferably, the side of the membrane facing the product contains said pigments or said print design. Another example of a coloured membrane can be a membrane made from a material that includes particles of substances with special luminescent or fluorescent properties. Such coloured elements are preferably made of edible materials so that the valve may be used in food packaging. Preferably, said membrane may comprise, within it or on at least one of its surfaces, fluorescent or chemoluminescent markers, which are able to react with the aldehydes and the ketones released by the oxidized product and to emit a light signal in the visible or ultra-visible range. Said fluorescent or chemoluminescent markers may be for instance Dichlorofluorescin diacetate (DCFDA), Dihydrorodamine 123 (DHR), Dichloeoethidium (DHE) and/or Luminol. These markers may be included in the membrane matrix or smeared on it or even distributed on its surface by means of lacquering or spray.

According to the present invention, a method is provided to detect the oxidation state of the product contained in the package comprising a valve according to the previous paragraph, by determining the variation in colour of the valve membrane.

According to an embodiment of the present invention, a one-way relief valve is provided, wherein the colour of the valve membrane is different from the colour of the valve body. The advantage of producing a membrane having a different colour from the valve body is that such a membrane is made easily recognisable during the various steps of the assembly and the production of the valve and/or of the hermetically sealed packages provided with the valve.

According to an embodiment of the present invention, a one-way relief valve is provided, wherein the body of the valve is white. In fact, the body of relief valves is typically made of plastic materials, both non-biodegradable and biodegradable, which have a white colour under the conditions of thickness, which are required for producing the valves. In addition, the white colour of the valve body is particularly advantageous because the membrane having different colours stands out.

According to an embodiment of the present invention, a one-way relief valve is provided, wherein the valve membrane is coloured with a specific colour depending on the features of the membrane, for example the type of material or the opening pressure, which are intended to be highlighted. For example, the membrane can be coloured in light blue, if it is made of recyclable materials, or it can be coloured in green, if it is made of compostable materials, or it can be coloured in yellow if it has a specific opening pressure, for example 0.004 bar.

According to an embodiment of the present invention, a one-way relief valve is provided, wherein the valve comprises an upper surface connected with side walls to the lower supporting surface of the valve body. The upper surface does not cover the lower supporting surface and there are no other elements fixed to the upper surface covering the lower supporting surface. This configuration is particularly advantageous because it makes the coloured membrane easily visible from the outside. In fact, in addition to being coloured, the membrane is not covered or hidden by other elements of the valve body and is, therefore, detectable by an operator and/or a machine during the various steps of the assembly and the production of the valve and of the hermetically sealed packages provided with the valve.

According to an embodiment of the present invention, a one-way relief valve is provided in which the coloured membrane adheres to the lower supporting surface by means of a layer of oil. The advantage of this particular embodiment is that no additional fixing means are required to adhere the membrane to the lower supporting surface, and thus the amount of material required to produce the valve body is reduced and the membrane is easily visible.

According to an embodiment of the present invention, a one-way relief valve is provided, wherein the oil layer comprises, for example, silicone oil for alimentary use. The silicone oil is particularly suitable for use in relief valves for packages because it has a viscosity such that the membrane adheres to the body of the valve and can be opened if gas is released from the product in the package.

According to an embodiment of the present invention, a one-way relief valve is provided, wherein the valve membrane comprises at least one biodegradable material, for example a biodegradable material according to one or more of the following regulations: EN 13432, EN 14995, ASTM D 6400, ISO 18606:2013, ISO 17088:2008 and UNI 11183. This particular configuration of the membrane has the advantage of being environmentally sustainable. For example, the membrane can be made of biodegradable material to meet one or more of the listed regulations.

According to an embodiment of the present invention, a one-way relief valve is provided, wherein the biodegradable membrane material is made of polylactic acid (PLA). PLA is particularly suitable for producing membranes for relief valves because it is characterised by high rigidity even for thin thicknesses. Moreover, PLA is characterized by a high compatibility with the main colourants for alimentary use that are currently available and is, therefore, particularly advantageous for producing coloured membranes.

According to an embodiment of the present invention, a one-way relief valve is provided, wherein the valve membrane comprises a recyclable material, for example a recyclable material in accordance with one or more of the following regulations: directive 94/62/EC, ISO 18604:2013 and ISO 18606:2013. This particular embodiment of the membrane has the advantage of being environmentally sustainable. For example, the membrane can be made of recyclable material.

Preferably, the membrane is made of polyethylene terephthalate (PET). According to an embodiment of the present invention, a one-way relief valve is provided, wherein the valve body is made of biodegradable material, for example a biodegradable material according to one or more of the following regulations: EN 13432, EN 14995, ASTM D 6400, ISO 18606:2013, ISO 17088:2008 and UNI 11183. This particular embodiment of the valve body has the advantage of being environmentally friendly. Furthermore, if the biodegradable valve body is associated with the biodegradable coloured membrane, described according to an embodiment of the present invention, it is possible to obtain a relief valve that is entirely biodegradable and, therefore, highly advantageous from an ecological point of view.

According to an embodiment of the present invention, a one-way relief valve is provided, wherein the valve body is made of recyclable material, for example recyclable material in accordance with one or more of the following regulations: directive 94/62/EC, ISO 18604:2013 and ISO 18606:2013. This particular configuration of the valve body has the advantage of being environmentally friendly. Furthermore, if the recyclable valve body is combined with the recyclable coloured membrane according to an embodiment of the present invention, it is possible to obtain a fully recyclable relief valve and it is, thus, extremely advantageous from an ecological point of view. Preferably, the valve body is made of polyethylene (PE).

According to an embodiment of the present invention, a hermetically sealed package, preferably for foodstuffs, having such a one-way relief valve is provided. In this way, it is particularly easy to verify the correct positioning of the coloured membrane on the relief valve before attaching said valve to the package, thus reducing the risk of having packages with a valve not covered by the membrane, in which the product could lose its organoleptic properties. This solution is therefore particularly advantageous because it reduces the probability of having damaged products. Preferably, the valve membrane has a different colour depending on the type of material from which the membrane is made. This makes it particularly easy to identify the material of the valve membrane. In this way, it is preferable to combine hermetically sealed packages with membranes made of the same material. For example, the hermetically sealed packages may be made of a biodegradable material and, advantageously, the valve may be of a biodegradable material, i.e. it may comprise a biodegradable valve body and a biodegradable membrane. According to a further example, the hermetic package is made of recyclable material and, advantageously, the valve may be recyclable, i.e. it may comprise a recyclable valve body and a recyclable membrane. According to a further embodiment of the present invention, the material of the hermetic package is of the same type, i.e. recyclable or biodegradable, as the material of the valve body. In fact, it has been observed that adhering a valve body to a hermetic package made of the same type of material is easier and more effective than adhering materials of different types.

According to a further embodiment of the present invention, the hermetically sealed package is at least partially or entirely made of a transparent material, so that the valve with its membrane is visible from the outside. For example, the membrane, and in particular the inner side of the valve membrane exposed to the product, may comprise particular pigments or a particular pattern capable of reacting with the compounds released by the oxidised food (called secondary products), for example hydrocarbons, esters, aldehydes, ketones, alcohols, acids, so as to change colour. In this way, the colouring of the membrane makes it possible to verify the oxidation state of the product, for instance the oxidation state of the coffee contained in the package provided with the valve according to this embodiment of the invention. Preferably, said membrane may comprise, on its inner parts or on at least one of its surfaces, fluorescent or chemoluminescent markers, which are able to react with the aldehydes and the ketones released by the oxidized product and to emit a light signal in the visible or ultra-visible range. Said fluorescent or chemoluminescent markers may be for instance Dichlorofluorescin diacetate (DCFDA), Dihydrorodamine 123 (DHR), Dichloeoethidium (DHE) and/or Luminol.

According to the present invention, a method based on optical techniques for determining the correct assembly of a one-way relief valve for hermetically sealed packages, comprising a valve body and a flexible membrane, is provided. The method according to the invention comprises a step of optical detection of the membrane, in order to check its presence on the valve body. It is then possible to check whether the flexible membrane is actually attached to the valve body by detecting its presence due to its particular optical properties. For example, if the membrane is made of a mixture containing pigments or colourants, an optical detection method is used to detect the presence of these pigments or colourants. If the membrane has a layer of lacquer or other coloured material on at least one of its surfaces, an optical detection method for detecting such a layer of lacquer or coloured material is used. If the membrane is made of a mixture containing fluorescent or luminescent particles, an optical detection method for detecting the presence of such particles is used. For example, if the membrane comprise, within it or on at least one of its surfaces, fluorescent or chemoluminescent markers, which are able to react with the light having a predetermined wavelength, a method is used to detect the visible or UV light signal emitted by said markers. In this way, it is particularly easy to ascertain the correct positioning of the coloured membrane on the relief valve. This solution is therefore particularly advantageous because it reduces the probability of producing incorrectly formed valves. Non-limiting examples of fluorescent or chemoluminescent markers may be the markers which are able to react with the aldehydes and the ketones released by the oxidized product, for instance Dichlorofluorescin diacetate (DCFDA), Dihydrorodamine 123 (DHR), Dichloeoethidium (DHE) and/or Luminol.

According to the present invention, a machine for forming hermetically sealed packages having a one-way relief valve comprising a valve body and a membrane, is also provided. The machine according to the present invention comprises optical detection means configured to detect the presence of the membrane on the valve based on the colour. For example, if the membrane is made of a mixture containing pigments or colorants, means for detecting the presence of said pigments or colorants are used. If the membrane has a layer of lacquer or other coloured material on at least one of its surfaces, means for detecting such a layer of lacquer or coloured material are used. If the membrane is made of a mixture containing fluorescent or luminescent particles, means for detecting the presence of such particles are used. In this way, it is particularly simple to verify the correct position of the coloured membrane on the relief valve. This solution is therefore particularly advantageous because it reduces the probability of producing incorrectly formed valves. The machine may be configured for forming hermetically sealed packages provided with a relief valve according to one or more of the embodiments presented above.

### BRIEF DESCRIPTION OF THE FIGURES

The present invention will be described with reference to the accompanying figures, wherein the same numbers and/or reference signs indicate the same and/or similar and/or corresponding parts of the system.

FIG. 1 schematically illustrates a 3D view of a relief valve with a coloured membrane according to an embodiment of the present invention.

FIG. 2 schematically illustrates a 3D view of the valve body of a relief valve according to an embodiment of the present invention.

FIG. 3 schematically illustrates a side section view of the relief valve with coloured membrane from FIG. 1.

### DETAILED DESCRIPTION

In the following, the present invention will be described with reference to particular embodiments, as illustrated in the accompanying figures. However, the present invention is not limited to the particular embodiments described in the following detailed description and illustrated in the figures, but rather the described embodiments simply exemplify the various aspects of the present invention, the scope of which is defined by the claims. Further modifications and variations of the present invention will be apparent to the person skilled in the art.

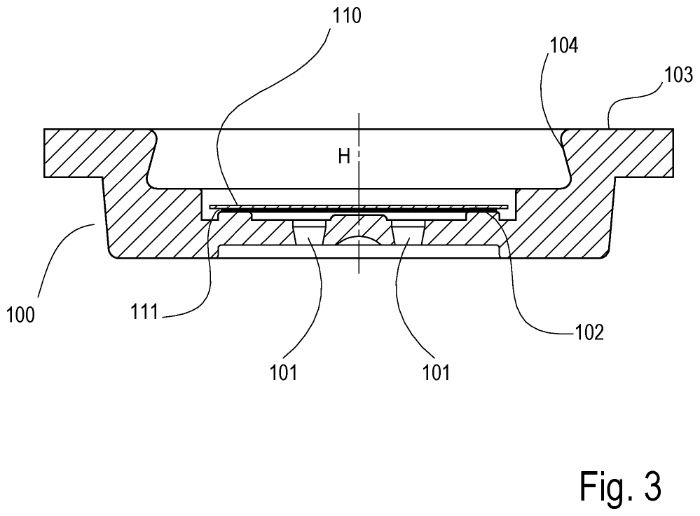

In the context of the present description, the terms “upper” and “lower” refer to different heights with respect to the vertical axis H originating in the centre of the valve and represented in FIG. 3. In particular, the term “lower” indicates an element on a level closer to the origin of the vertical axis H.

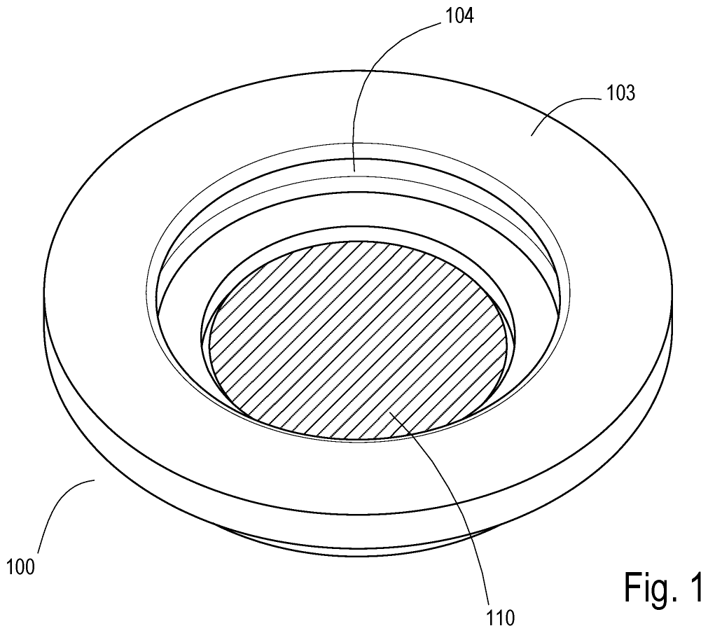

FIG. 1 schematically shows a 3D view of a one-way relief valve according to an embodiment of the present invention. The valve comprises a valve body 100 comprising two flat surfaces located at different heights, a lower supporting surface 102 and an upper surface 103, connected to each other by means of side walls 104. Preferably, the lower supporting surface 102, the upper surface 103 and the side walls 104 form a single valve body.

A coloured membrane 110 is placed on the lower supporting surface 102 of the valve. Said membrane is coloured in any colour other than the colour of the valve body 100, so as to be easily recognisable by an operator or a machine during the assembly of the valve and/or the production of the packages provided with said valve. The body of the valve 100 is preferably white. For example, the coloured membrane 110 may instead be blue, green or yellow. The coloured membrane 110 is thin, preferably having a thickness in the range of 0.012 mm to 0.2 mm, preferably having a thickness of 0.04 mm, so as to be sensitive to small variations in the pressure exerted by the gas inside the container. Since the membrane is thin, the fact that it is coloured is very advantageous in order to allow it to be recognisable from the outside. In fact, if it were transparent and not coloured, it would be very difficult to detect its presence by an operator and/or a machine during the production process of the valve.

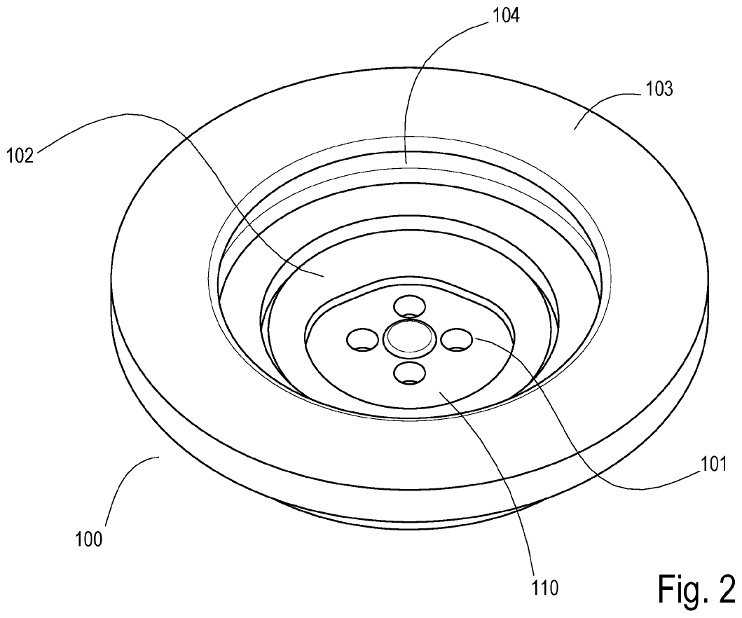

FIG. 2 shows a 3D view of a particular embodiment of the valve body 100. The lower supporting surface 102 of the valve body 100 comprises four vent holes 101.

FIG. 3 shows a side section of the one-way relief valve shown in FIG. 1. The adhesion of the coloured membrane 110 to the lower support surface 102 is enabled by the presence of a layer of oil 111, so that no additional fasteners of the coloured membrane 110 to the lower support surface 102 are required. For example, the layer of oil 111 may be silicone oil for alimentary use. Silicone oil is particularly suitable for use in relief valves for packages, because it has such a viscosity that the membrane is adhered to the valve body and can be opened if gas is released from the product in the package.

FIG. 3 also shows that the upper surface 103 is made in such a way that it does not cover the lower support surface 102 with any of its parts; in this way, the coloured membrane 110 can be easily recognised by an operator or a machine during the various steps of assembly and production of the valves and/or of the hermetically sealed packages equipped with a valve because, in addition to being coloured, it is not covered by any element.

The relief valve, once assembled, can be applied to the inside of the hermetically sealed package so that the upper surface 103 is in contact with the inside wall of the package and so that the lower supporting surface 102 with the vent holes is placed towards the product.

The coloured membrane 110 is flexible and can switch from a position where the valve is closed, because the vent holes 101 of the valve body are entirely covered by the membrane retained by the layer of oil 111, to a position where the valve is open, because the membrane has at least partially detached itself from the layer of oil 111, clearing the vent holes 101 of the valve body as a result of the pressure of the gas released by the product contained in the package.

The membrane 110 is coloured with any colour other than the colour of the valve body, so as to be easily recognisable by the operator and/or the machines during the assembly of the valves and/or the production of the packages equipped with the valves. In this way, when the valves are attached to the hermetically sealed packages, it is particularly easy to ensure that they have been correctly assembled and that they include the coloured membranes. As a result, the risk of producing packages with valves that do not have membranes, which would cause the product to be unintentionally exposed to the external environment and thus lose its organoleptic properties, is reduced.

The coloured membrane 110 and/or the valve body 100 are, for example, made of biodegradable materials, e.g. polylactic acid (PLA), in order to be environmentally friendly.

Alternatively, the coloured membrane 110 and/or the valve body 100 may be made of recyclable materials in order to be environmentally friendly. For example, the valve body may be made of polyethylene (PE) and the membrane may be made of polyethylene terephthalate (PET).

Although the present invention has been described with reference to the embodiments described above, it is clear to the skilled person that various modifications, variations and improvements of the present invention are possible in the light of the teachings described above and within the scope of the appended claims, without departing from the object and scope of protection of the invention.

For example, even if a valve is shown in which the coloured membrane has the shape of a small disc, it is clear that it is also possible to make the coloured membrane with other shapes, for example with a square or rectangular shape. Similarly, even if a valve is shown in which the valve body has a circular perimeter, it is apparent that it is also possible to make the valve body with other shapes, for example with a square or rectangular perimeter.

Furthermore, although it has been described that the valve body can be white, it is evident that it is also possible to make the valve body in other colours and to adapt the colour of the coloured membrane accordingly so that it differs from the colour of the valve body and is, therefore, easily visible by the operator or the machine during the production of the valve and/or the hermetically sealed packages provided with the valve.

Finally, those areas, which are considered to be known to the skilled person, have not been described in order to avoid unnecessarily overshadowing the described invention.

For example, it has not been described how to assemble the one-way relief valves wherein the membrane is attached to the valve body by a layer of oil, since this process is known to those skilled in the art. Furthermore, it has not been described how to produce hermetically sealed packages equipped with one-way relief valves with a coloured membrane such as those described in the present invention, since this production method is similar to the one employed for producing hermetically sealed packages equipped with any relief valve and is, therefore, known in the state of the art.

Accordingly, the invention is not limited to the embodiments described above, but is only limited by the scope of protection of the appended claims.

1. A one-way relief valve for hermetically sealed packages comprising:
a valve body comprising a lower supporting surface provided with one or more vent holes and an upper surface connected with lateral walls to said lower surface, and
a membrane coupled with said lower supporting surface and movable from a configuration in which said valve is closed to a configuration in which said valve is open,
wherein said membrane comprises pigments and/or colorants so that said membrane is colored.

2. The one-way relief valve according to claim 1, wherein a color of said membrane is different from a color of said valve body.

3. The one-way relief valve according to claim 1, wherein said valve body is white.

4. The one-way relief valve according to claim 1, wherein said membrane is blue, green or yellow.

5. The one-way relief valve according to claim 1, wherein said membrane is configured so as to change color by reacting with one or more compounds released from the package, for instance following an oxidation reaction of the product contained into the package, for instance hydrocarbons, esters, aldehydes, ketones, alcohols, acids.

6. The one-way relief valve according to claim 1, wherein said valve body comprises an upper surface connected to said lower supporting surface with lateral walls, wherein said membrane is not covered by elements fixed to said upper surface or to said lateral walls, so as to be immediately visible to a user.

7. The one-way relief valve according to claim 1, wherein said colored membrane adheres to said lower supporting surface by means of a layer of oil, so that no further fixing means are required to keep said membrane adhered to said valve body.

8. The one-way relief valve according to claim 7, wherein said layer of oil comprises silicone oil.

9. The one-way relief valve according to claim 1, wherein said membrane comprises at least one biodegradable material, for example a biodegradable material according to one or more of the following regulations: EN 13432, EN 14995, ASTM D 6400, ISO 18606:2013, ISO 17088:2008 and UNI 11183.

10. The one-way relief valve according to claim 9, wherein said biodegradable material is polylactic acid (PLA).

11. The one-way relief valve according to claim 1, wherein said membrane comprises at least one recyclable material, for example a recyclable material according to one or more of the following regulations: directive 94/62/EC, ISO 18604:2013 and ISO 18606:2013.

12. The one-way relief valve according to claim 1, wherein said valve body comprises at least one biodegradable material, for example a biodegradable material according to one or more of the following regulations: EN 13432, EN 14995, ASTM D 6400, ISO 18606:2013, ISO 17088:2008 and UNI 11183.

13. The one-way relief valve according to claim 1, wherein said valve body comprises at least one recyclable material, for example a recyclable material according to one or more of the following regulations: guidelines 94/62/EC, ISO 18604:2013 and ISO 18606:2013.

14. An airtight package, preferably for food, comprising a one-way relief valve according to claim 1.

15. The airtight package according to claim 14, wherein said airtight package is realized at least partially or entirely in transparent material, so that said relief valve is visible from the outside.

16. A method for establishing the correct assembly of a one-way relief valve for hermetically sealed packages comprising:
a valve body comprising a lower supporting surface provided with one or more vent holes and an upper surface connected with lateral walls to said lower surface,
a membrane coupled with said lower supporting surface and movable from a configuration in which said valve is closed to a configuration in which said valve is open,
wherein said membrane comprises pigments and/or colorants so that said membrane is colored, and
said method comprises an optical detection step of said membrane, for example on the basis of the color, in order to verify the presence of said membrane.

17. The method according to claim 16, wherein said one-way relief valve is a valve according claim 1.

18. A machine for the production of hermetically sealed packages comprising a one-way relief valve comprising:
a valve body comprising a lower supporting surface provided with one or more vent holes and an upper surface connected with lateral walls to said lower surface,
a membrane coupled with said lower supporting surface and movable from a configuration in which said valve is closed to a configuration in which said valve is open,
wherein said membrane comprises pigments and/or colorants so that said membrane is colored, and
said machine comprises optical detection means configured to detect the presence of said membrane on the valve, for example on the basis of the color.
